(19) United States
(12) Patent Application Publication
(10) Pub. No.: US 2006/0293961 A1
(43) Pub. Date: Dec. 28, 2006

(54) System and method for reward-based content distribution

(76) Inventor: Eran Elias, Even-Yehuda (IL)

Correspondence Address: Martin D. Moynihan;PRTSI, Inc., P.O. Box 16446, Arlington, VA, 22215, US

(21) Appl. No.: 11/475,922

(22) Filed: Jun. 28, 2006

Related U.S. Application Data
(60) Provisional application No. 60/694,265, filed on Jun. 28, 2005.

(51) Int. Cl. G06Q 30/00

(52) U.S. Cl. 705/14

(57) ABSTRACT

A reward-based content distribution includes an access analyzer and a reward generator. The access analyzer analyzes an access to content by an accessing user so as to determine an originating user indicated by the customized identifier via which said content was accessed. The reward generator rewards the originating user for the access.

### RELATED APPLICATIONS

This application claims the benefit of U.S. Provisional Patent Application No. 60/694,265, filed Jun. 28, 2005, which is herein incorporated in its entirety by reference.

### FIELD AND BACKGROUND OF THE INVENTION

The present invention relates to rewarding users for distributing content or access to content to other users and, more particularly, but not exclusively to rewarding users for distributing content by sending a content item or a link to the content item to another user.

Incentive programs are a mechanism by which vendors promote the sales of products and services and increase customer loyalty. In an incentive program, the vendor rewards customers for their actions, often by a point system. Commonly, rules are established to determine how many points are awarded for each participant action and how many points participants must accumulate to be entitled to certain rewards. Frequent flyer programs are a well-known incentive program. Incentive programs have also been developed to encourage customers to promote an item or vendor to other people.

With the spread of e-commerce, incentive programs have been developed for the Internet. In one type of Internet incentive program, a website owner posts a link to an Internet vendor. The website owner is rewarded for the activities of customers who reach the vendor through the posted link. A disadvantage of this type of incentive program is that the website owner does not promote the vendor directly to others. Only people who independently access the original website will see the link. These people often have no interest in the vendor's goods or services, and so the posted link may be ineffective.

Another type of Internet incentive program is by customer recommendation. For example, a customer making a purchase with an Internet vendor is requested to recommend the vendor or purchased item to a friend. The customer is requested to enter a friend's email address, and an email is automatically sent by the vendor to the friend to notify him of the recommendation. The original customer is then rewarded for the friend's transactions with the vendor. Again, there is no active promotion by the customer to others. Many customers choose not to make any recommendations, thus limiting the incentive program's effectiveness.

A third Internet incentive program utilizes a file which when viewed sends a notification to a reward platform that the file has been viewed. The promoter of the file is then rewarded. However, many servers and routers block this type of file, and thus the promoter does not consistently get rewarded when the file is viewed, consequently reducing the promoter's incentive.

U.S. patent application Ser. No. 2002/0147633 by Rafizadeh presents an interactive advertisement and reward system, which aggregates product information and advertisements on a web set, and rewards customers for activities such as browsing advertisements and answering questionaires. Rafizadeh's system includes a membership referral engine which monitors data relating to new members who have been referred to the system by existing members. However, the membership referral engine has no independent means for knowing that a new member has been referred by an existing member. The new member must explicitly report that he or she has been referred. Since there is no guarantee that the new member will report this information, the existing member has limited incentive to recruit new members.

The Internet incentive programs described above are of limited utility in encouraging users to promote a vendor, item or service. To be effective, an incentive program should target users who are motivated to actively direct others to a desired e-commerce activity, such as purchasing a particular item or viewing an advertisement, and should ensure that such users are consistently rewarded for their efforts.

There is thus a widely recognized need for, and it would be highly advantageous to have, a reward system devoid of the above limitations.

### SUMMARY OF THE INVENTION

According to a first aspect of the present invention there is provided a reward-based content distribution which includes an access analyzer and a reward generator. The access analyzer analyzes an access to content by an accessing user so as to determine an originating user indicated by the customized identifier via which said content was accessed. The reward generator rewards the originating user for the access.

According to a second aspect of the present invention there is provided a method for reward-based content distribution. The method consists of: analyzing an access to content by an accessing user so as to determine an originating user indicated by an identifier via which the content was accessed, and rewarding the originating user for the access.

According to a third aspect of the present invention there is provided a method for reward-based content distribution. The method consists of: enabling a user to distribute content to recipients, monitoring the distribution of the content by the user to the recipients, and rewarding the user for the distribution.

The present invention successfully addresses the shortcomings of the presently known configurations by providing system and method for reward-based content distribution.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram of a reward-based content distribution system, according to a first preferred embodiment of the present invention.

FIG. 2 is a simplified flow chart of a method for reward-based content distribution, according to a preferred embodiment of the present invention.

FIG. 3 is a simplified block diagram of a client for a communication device, according to a first preferred embodiment of the present invention.

FIG. 4 is a simplified flowchart of a method for reward-based distribution of content between users, according to a second preferred embodiment of the present invention.

FIG. 5 is a simplified block diagram of a reward-based content distribution system, according to a second preferred embodiment of the present invention.

FIG. 6 is a simplified block diagram of a client for a communication device, according to a second preferred embodiment of the present invention.

FIG. 7 is a simplified block diagram of an Interactive Rewarding Media Platform.

### DESCRIPTION OF THE PREFERRED EMBODIMENTS

The present embodiments teach a reward-based content distribution for rewarding users for distributing content such as web site links or media files to other users. Specifically, the present embodiments teach the use of customized links to identify an originating user who distributed access to the content to an accessing user.

Currently, Internet incentive programs are of limited effect in encouraging users to actively promote a vendor, product or the like. The present embodiments enable the implementation of an Internet incentive program for users who actively distribute content to other users, in a manner that ensures that the distributers are accurately rewarded for their efforts. The content is preferably provided to other users by sending a customized link to other users, thus enabling other users to access the content via a web page. In an alternate preferred embodiment, the content is forwarded directly from one user to the next.

The principles and operation of a reward-based content distribution system and method according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

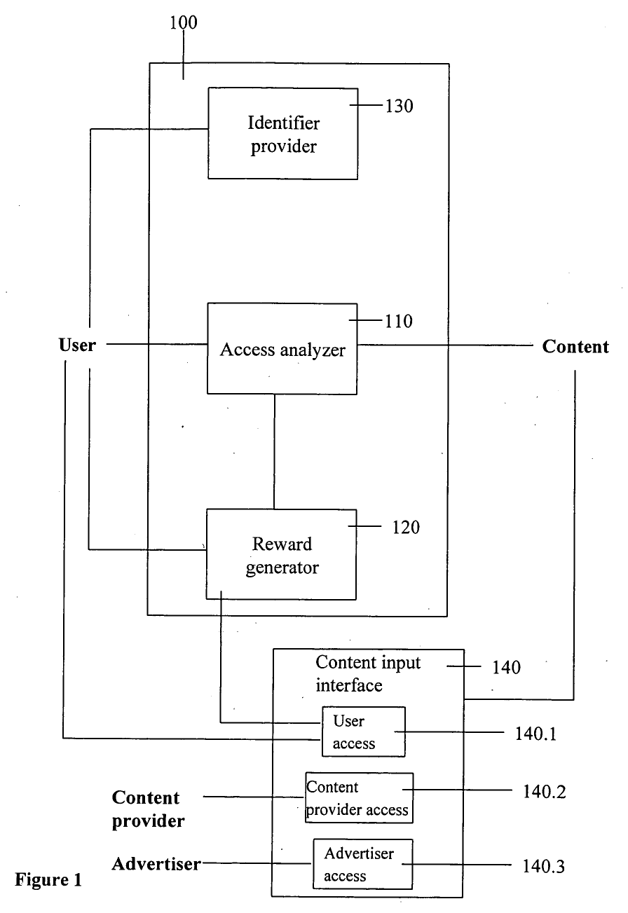

Reference is now made to FIG. 1, which is a simplified block diagram of a reward-based content distribution system, according to a first preferred embodiment of the present invention. Content distribution system 100 includes access analyzer 110 and reward generator 120. In the preferred embodiment, a customized identifier is sent to a user (denoted herein the originator or originating user) who distributes the identifier to other users. The identifier enables access to the content. The description below is directed to a non-limiting preferred embodiment in which the content is a web site and the identifier is a link for accessing the web site. The link is preferably customized so that when the website is accessed the originator can be identified by analyzing the link by which the web site was entered.

The term user denotes herein any individual who is related to the reward process, whether by forwarding content, enabling content access, or by accessing the content.

Access analyzer 110 analyzes accesses to the content, where the access preferably consists of accessing a web site. When a given web site is accessed, access analyzer 110 first determines the link by which the web site was accessed (denoted herein the access link), and then analyzes the access link to determine the associated originator. Preferably, access analyzer 110 analyzes an access link only if the accessing link is a customized link. After the associated originator has been determined, access analyzer 110 informs reward generator 120 that a web site access occured for the originator. Access analyzer 110 preferably also informs reward generator 120 of further activities resulting from the web site access, such as purchases performed via the web site or the viewing of an advertisement posted on the web site.

Reward generator 120 is the reward platform which determines the reward due to the originator based on information provided by access analyzer 110. The reward may be calculated in many ways. Preferably, the originator is rewarded for each (or selected) access to the website via his customized link and/or for further activities of the accessing user. Reward generator 120 may also base the user award on other factors, such as rewarding more successful originators with more points per access.

System 100 preferably further includes identifier provider 130 which provides customized identifiers to users. The identifier is customized to indicate the user to whom the link is sent. The customized identifier is preferably forwardable from user to user (a user who received the identifier by forwarding from another user is denoted herein a recipient). Forwarding is preferably performable by one or more of: email, short message service (SMS), the Internet, and instant messaging (IM). When a given recipient (denoted herein the forwarder) forwards a link to a second recipient, the link may be modified to indicate the forwarder, so that reward generator 120 may reward the forwarder for access via the forwarded link. (The forwarder thus serves serve as the “originator” for the second recipient.) Although the above is directed to an embodiment in which the content consists of a web site accessed via the identifier, other embodiments provides access to the content, and is not the content itself. In a first preferred embodiment, the content is a media item, such as a video or audio file. The media file may include, for example, movie trailers, song clips, product placement, and/or special movies. Accessing the media file may consist of downloading the file, listening to, or viewing the file (for example by streaming). In an alternate preferred embodiment, the content is an advertisement which may be viewed or entered via the web site. Content may also consist of a link to another web site.

In the preferred embodiment, system 100 further includes content input interface 140, which serves for the input of content items which may be distributed by system 100. Interface 140 preferably includes separate interfaces for content input by users (User access 140.1) , content providers (Content provider access 140.2), and advertisers (Advertiser access 140.3).

User access 140.1 is an interface for users to input content which may be distributed to other users. The user may provide an identifier for accessing the content, which is preferably customized by system 100 before distributing to other users. Alternately, the user may provide content such as a media file, in which case system 100 preferably manages access to the content via the customized identifiers. Reward generator 120 may reward users who provide content, possibly on a varying scale according to the nature of the provided content and other factors.

Content provider access 140.2 is an interface for inputting content from other sources, for example from a publisher interested in promoting a book.

Advertiser access 140.3 is an interface for advertisers providing adverstising information, such as banners, media files, and web site links. Advertisers may also be define how the advertisement should be managed by system 100, for example by specifying a target group of users to whom the advertisement should be distributed. Advertisements may optionally be inserted into the content provided by users and other sources before distribution.

System 100 preferably further includes one or more of:

1) A user registration unit which obtains user information and registers users. All or a selected group of the registered users may serve as originators.

2) A database for storing user information

3) A data miner which analyzes activities by accessing users, forwarders and/or originators. The data obtained may be provided to third parties, such as advertisers.

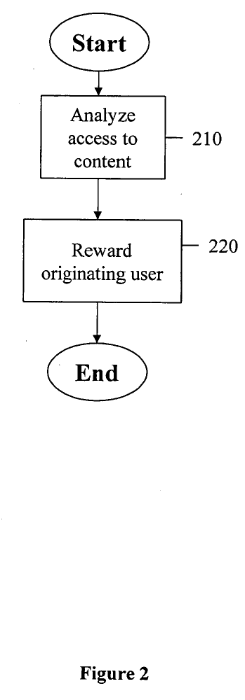

Reference is now made to FIG. 2, which is a simplified flow chart of a method for reward-based content distribution, according to a preferred embodiment of the present invention. In step 210, an access to content (such as a web site) is analyzed. The content is accessed by a customized identifier, which as discussed above includes an indication of an originating (or forwarding) user. The analysis determines the originator indicated by the identifier via which the content was accessed. In step 220, the originator is rewarded for the access.

The method preferably includes the further step of providing a user with a customized identifier. For example, a given user may be provided with a link to a web site, such that when the web site is accessed via the link the given user may be identified. The identifier is preferably forwardable from from one user to another user, for example by emailing the link.

In the preferred embodiment, the method includes the further step of inputting content from a content provider, such as a user, advertiser or other source. Preferably, the user is rewarded for providing the content.

The method preferably includes one or more of the following steps:

1) Calculating a reward for a given access and/or accessing user activities resultant from the access.

2) Obtaining user information and registering users.

3) Storing the user information in a database.

4) Analyzing user access activities to obtain a user profile.

5) Providing the user profile(s) to a third party, such as an advertiser or vendor.

6) Incorporating advertising information into the web site.

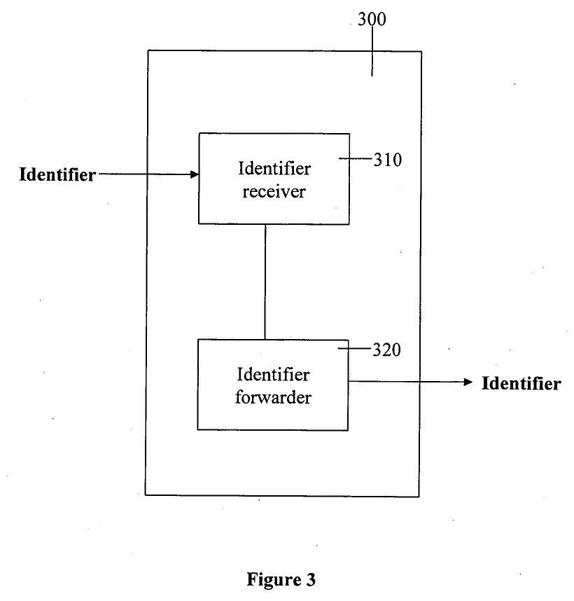

Reference is now made to FIG. 3, which is a simplified block diagram of a client for a communication device, according to a first preferred embodiment of the present invention. Client 300 includes identifier receiver 310 and identifier forwarder 320. Identifier receiver 310 receives customized identifiers for accessing content, where the identifier is customized to indicate an originator when the content is accessed. The identifier may be received directly from a reward system or from another user device (such as a cell phone, PDA or computer).

Identifier forwarder 320 forwards the customized identifier to recipient users. The originator may thus be rewarded for accesses to the content made via the identifier. In the preferred embodiment, identifier forwarder 310 informs a reward system when an identifier is forwarded.

In a first preferred embodiment the device is a cellular telephone. In a second preferred embodiment the communication device is a wireless handheld device, such as a Blackberry. In a further preferred embodiment the device is a personal digital assistant (PDA).

Preferably, when identifier forwarder 320 forwards the link to a recipient, identifier forwarder 320 modifies the identifier to indicate the user associated with the device (i.e. the owner). When modifying the link, identifier forwarder 320 may remove indications of previous forwarders.

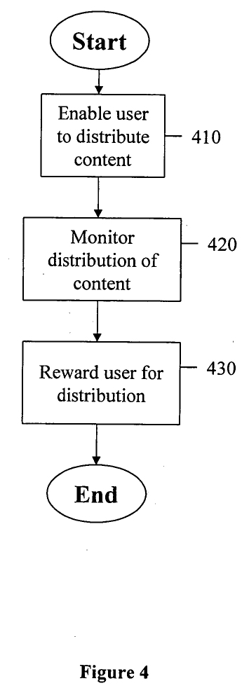

Reference is now made to FIG. 4, which is a simplified flowchart of a method for reward-based distribution of content between users, according to a second preferred embodiment of the present invention. In the preferred embodiment of FIG. 4, the content itself is sent from one user to the next. The content may consist of a media file, advertisement, or link to a web site.

In step 410, a user is enabled to distribute content to recipients. In step 420, the distribution of the content by the user to recipients is monitored. In step 430, the user is rewarded for the distribution. In the preferred embodiment, enabling the user to distribute content consists of providing forwardable content to the user. In an alternate preferred embodiment, the user downloads the forwardable content.

Preferably, the method includes the further step of tracking user and recipient communications to determine a pathway of content distribution. The distribution of the content from user to user is monitored, so that one or more of the forwarding users may be rewarded, and/or so that originating user may be rewarded not only for recipients to whom he provided the content directly, but also to recipients who received the content through him indirectly.

Preferably, the method includes the further step of calculating a user reward in accordance with the number of recipients to whom the content is distributed by the user. The reward may also be calculated based on recipient activities resultant from content distribution by the user.

In the preferred embodiment, the method includes the further step of inputting content from a content provider, such as a user, advertiser or other source. Preferably, the user is rewarded for providing the content.

The method preferably includes one or more of the following steps:

1) Maintaining a database of information regarding the user and recipients.

2) Providing the information to a third party.

3) Including an advertisement in the content.

In a further preferred embodiment, content is distributed amongst registered subscribers. The method preferably includes the further steps of selecting initiating users from the registered subscribers, and providing the content to the initiating users.

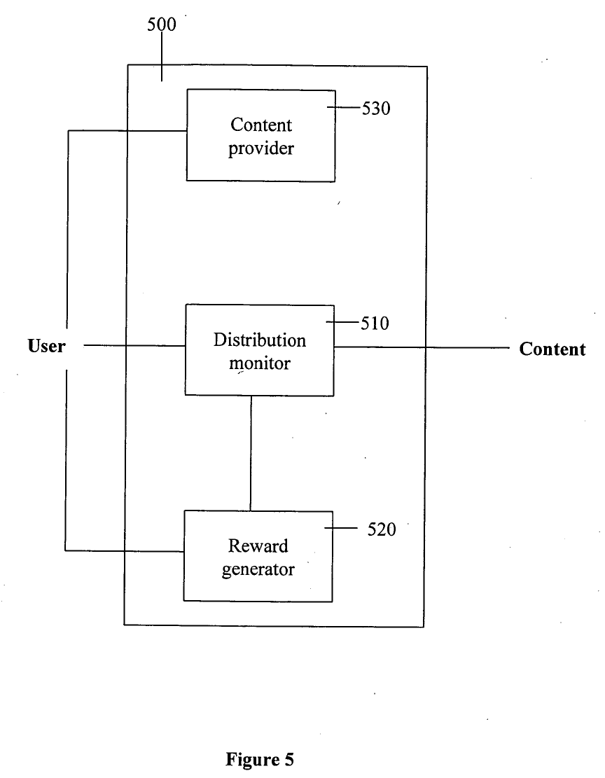

Reference is now made to FIG. 5, which is a simplified block diagram of a reward-based content distribution system, according to a second preferred embodiment of the present invention. System 500 includes a distrubtion monitor which monitors the distribution of content by the user to recipients, and reward generator 520 which rewards the user for distributing the content. System 500 may also include content provider 530, which provides forwardable content to the ser.

Preferably, system 500 further includes a content input interface similar to content input interface 140 of FIG. 1, for inputting content from users and other sources.

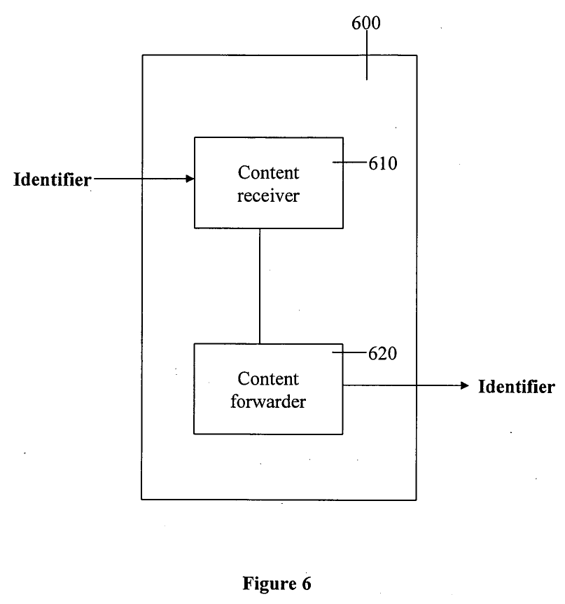

Reference is now made to FIG. 6, which is a simplified block diagram of a client for a communication device, according to a second preferred embodiment of the present invention. Client 600 includes content receiver 610 and content forwarder 620. Content receiver 610 receives customized content. The content may be received directly from a reward system or from another device (such as a cell phone, PDA or computer). Content forwarder 620 forwards the content to another user and informs the reward system of the forwarding. The device owner can thus be rewarded for forwarding the content.

The following presents an exemplary embodiment of a reward-based content distribution system, denoted herein an Interactive Rewarding Media Platform. The Interactive Rewarding Media Platform enables the distribution of rich media messages among registered subscribers and their contacts through e-mail, phone communication and instant messaging. The platform provides subscribers with immediate feedback to keep them apprised of their current reward points for the deliveries and activities they accomplish.

The platform sends out rich media content to subscribers. This content can include movie trailers, song clips, product placement, and special movies to predefined, registered subscribers. These subscribers are encouraged to forward the content on to their contact lists via e-mail , cell phone, or Instant messaging. A subscriber may, for example, send an e-mail to their entire address book or send the content to a group of friends by using a 3G cell phone.

Each subscriber registers for the platform by providing contact details or by paying some type of fee. After this, the subscriber becomes eligible to receive the reward points for delivering the media to his/her contacts. Points may be awarded for delivery exposures and other activities.

Additionally, registered subscribers have direct access to the business web site. These subscribers have the option of downloading the media themselves from the web and forwarding the downloaded media on to their contacts.

After a subscriber has collected a certain amount of reward points, he/she are be able to redeem their points for money and/or prizes.

Using a multi-level marketing system, subscribers may also be rewarded for the delivery and activity of their contacts to whom they first sent the messages. This means that subscribers are rewarded for the activity of their ‘agents’.

The following are features that the platform includes:

1. A built-in network of subscribers that agree to deliver media content in exchange for reward points.

2. A chosen list of initiators from the total registered subscribers.

3. Follow-up media exposure and communication between subscribers, including the origin from which the content was sent.

The platform may be implemented on software on the subscriber's device or by a downloaded client, but is not limited to these methods.

Communications between subscribers, including e-mail, instant messaging and phone messaging are tracked. This is in order to determine the pathway by which the media is distributed, so that the subscriber may be properly rewarded.

In the case of one person receiving the content from several users or subscribers, the platform may award only the subscriber who provided the first exposure.

In the case of one person being exposed to the media, he will not receive the content again. For example, if a given subscriber has already been exposed to the media, other users that try to send him the same message will receive a notice that the given subscriber has already been exposed to that particular message.

The platform preferably also includes a interface for receiving feedback from subscribers. Subscribers may provide feedback regarding the media itself such as text messages and/or selecting from a list of predefined content levels.

The differing numbers of points may be awarded of different points for various activities. These activities include forwarding content, providing feedback, registration, and the like.

Other platform features preferably include one or more of:

1) Providing the subscriber with an isolated and unique e-mail address, in order to categorize the different e-mail addresses for one entity subscriber.

2) A mechanism for providing more money per reward point, as long as the subscriber accumulates more points.

3) A stop, change, replace message for certain campaigns, according to the exposures and feedback from customers.

4) Document reports for advertisers detailing their exposures, according to demographic characteristics.

5) Document reports to subscribers detailing the reward points they have accumulated.

The above described platform enables rapid distribution of content to a large number of people. Consider an example in which the platform initially sends the media to 10,000 people. We assume that in each step 20% of recipients forward the content on to new friends

Each one of the original 10,00 forwards the content to 25 new contacts. New exposures for the first stage are 250,000. Out of the 250,000 new subscribers, 50,000 of them forward the media to 15 new subscribers, yielding 750,000 new exposures for the second stage. In the third stage, 150,000 subscribers send the content to 5 new contacts, again yielding 750,000 new subscribers. Thus the content reaches 1,750,000 subscribers with three stages of forwarding between users.

If a subscriber is awarded a fixed number of points each new exposure, the direct “cost” to the platform is the number of new exposures multiplied by the fixed number of points. Additionally, a subscriber may receive a portion of the points his ‘agents’ accrue for the content.

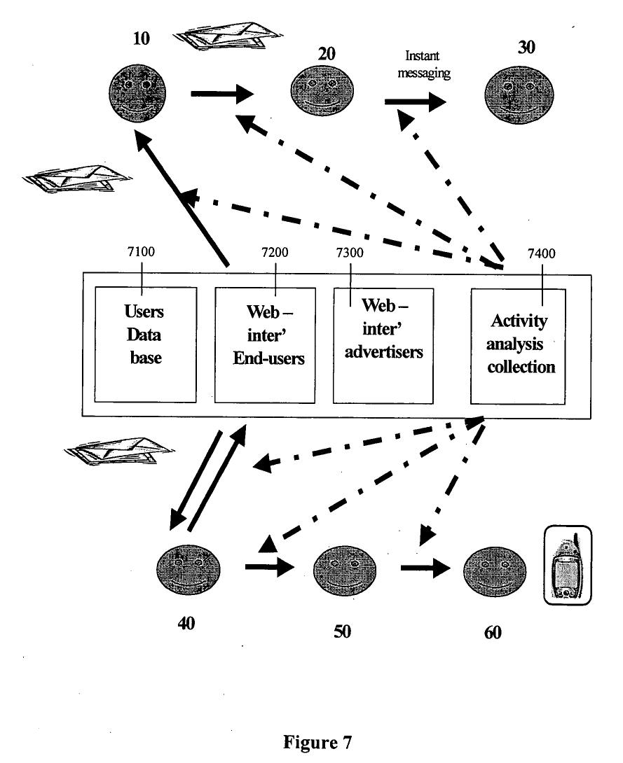

Reference is now made to FIG. 7, which is a simplified block diagram of a reward-based content distribution system (denoted herein the Interactive Rewarding Media Platform), according to a third preferred embodiment of the present invention. The platform includes four main components:

1) 7100 Subscribers database unit contains subscriber information including characteristics, activity, etc.

2) 7200 Web interface subscribers unit provides an interface to register into the system for subscriber. The Web interface subscribers unit allows subscribers to check their point status and redeem reward points for prizes.

3) 7300 Web interface advertisers unit provides an interface for the advertisers to present their campaign activity.

4) 7400 Activity analysis collection unit is responsible for tracking end-subscriber activity, such as total exposures to the media, e-mail forwards to friends and even which friends opened the content that the subscriber sent.

The Activity analysis collection unit is also responsible for identifying unique entities, and preventing fraud.

FIG. 7 illustrates methods for content delivery and forwarding. The platform sends the content to subscriber 10. Subscriber 10 then sends the content to subscriber 20. Subscriber 20 sends the content on to subscriber 30 through instant messaging. Each time the content is sent between subscriber and contacts, the system tracks the required information in order to reward the subscribers and produce reports for the advertisers. Subscriber 40 does not wait to receive a content message from the media center but downloads the material from the web site and sends it to subscriber 50. Subscriber 50 then forwards it to subscriber 60's phone.

Utilizing the embodiments described above, effective Internet incentive plans may be developed. These plans will encourage the promotion of websites and/or content by motivated users. Possible income sources for the incentive plan include advertisers, vendors and web site owners.

It is expected that during the life of this patent many relevant incentive plans, forwarding mechanims, communication devices, platforms, and content will be developed and the scope of the corresponding terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A reward-based content distribution system, comprising:
an access analyzer, operable to analyze an access to content by an accessing user so as to determine an originating user indicated by a customized identifier via which said content was accessed; and
a reward generator associated with said access analyzer, operable to reward said originating user for said access.

2. A system according to claim 1, wherein said content comprises a web site and said identifier comprises a link to said web site.

3. A system according to claim 2, further comprising an identifier provider operable to provide said originating user with an identifier for accessing said web site, wherein said identifier is customized to indicate said user.

4. A system according to claim 1, wherein said identifier is forwardable by an originating user to a first recipient.

5. A system according to claim 1, further comprising a content input interface for inputting content from a content provider.

6. A system according to claim 5, wherein said content provider comprises a user, and wherein said reward generator is operable to reward said user for providing said content.

7. A system according to claim 5, wherein said content input interface is further operable to incorporate advertising information into said user-provided content.

8. A system according to claim 4, wherein said reward generator is operable to reward said originating user for activities resultant from said access.

9. A system according to claim 2, wherein said web site is accessible by a plurality of identifiers, and wherein each of said identifiers is associated with a respective user.

10. A system according to claim 2, wherein said web site enables access to a media item.

11. A system according to claim 2, wherein said web site comprises an advertisement.

12. A method for reward-based content distribution, comprising:
analyzing an access to content by an accessing user so as to determine an originating user indicated by an identifier via which said content was accessed; and
rewarding said originating user for said access.

13. A method according to claim 12, further comprising providing a user with an identifier for accessing a web site, wherein said identifier is customized to indicate said user.

14. A method according to claim 12, wherein said identifier is forwardable by a first user to a second user.

15. A method according to claim 12, further comprising incorporating advertising information into said content.

16. A method according to claim 12, further comprising inputting said content from a user, and rewarding said user for providing said content.

17. A method for reward-based distribution of content between users, comprising:
enabling a user to distribute content to recipients;
monitoring the distribution of said content by said user to said recipients; and
rewarding said user for said distribution.

18. A method according to claim 17, wherein said enabling comprises providing forwardable content to said user.

19. A method according to claim 17, wherein said enabling comprises providing content for download over a network.

20. A method according to claim 17, wherein said content comprises one of a group comprising: an web site address, a media file, and an advertisement.

21. A method according to claim 17, wherein said rewarding comprises calculating a user reward in accordance with a number of recipients to whom said content is distributed by said user.

22. A method according to claim 17, wherein said rewarding comprises calculating a user reward in accordance with recipient activities resultant from content distribution by said user.

23. A method according to claim 17, further comprising tracking user and recipient communications to determine a pathway of content distribution.

24. A method according to claim 17, further comprising incorporating advertising information into said content.

25. A method according to claim 17, further comprising inputting said content from a user, and rewarding said user for providing said content.
